(19) United States
(12) Patent Application Publication
(10) Pub. No.: US 2016/0112502 A1
(43) Pub. Date: Apr. 21, 2016

(54) DISTRIBUTED COMPUTING BASED ON DEEP PACKET INSPECTION BY NETWORK DEVICES ALONG NETWORK PATH TO COMPUTING DEVICE

(71) Applicant: Cisco Technology, Inc., San Jose, CA (US)

(72) Inventors: JOSEPH MICHAEL CLARKE, Cary, NC (US); GONZALO SALGUEIRO, Raleigh, NC (US); MICHAEL DAVID HANES, Lewisville, NC (US)

(21) Appl. No.: 14/518,795

(22) Filed: Oct. 20, 2014

(51) Int. Cl. H04L 29/08; H04L 12/26

(52) U.S. Cl. CPC H04L 67/104; H04L 43/10

(57) ABSTRACT

In one embodiment, a method comprises: determining application processing capabilities in one or more network devices, in a data network, for execution of at least a portion of a prescribed application on identifiable data packets from a requesting network device and destined for a computing device; and sending instructions to the one or more network devices, the instructions enabling the one or more network devices to execute at least the portion of the prescribed application, on behalf of the computing device, in response to detecting receipt of the identifiable data packets.

### TECHNICAL FIELD

The present disclosure generally relates to distributed computing in a data network, more particularly to deep packet inspection by network devices on a network path from a requesting network device to a destination computing device.

### BACKGROUND

This section describes approaches that could be employed, but are not necessarily approaches that have been previously conceived or employed. Hence, unless explicitly specified otherwise, any approaches described in this section are not prior art to the claims in this application, and any approaches described in this section are not admitted to be prior art by inclusion in this section.

Distributed computing can involve multiple computing devices providing a given service, where each computing device can share in providing the given service based on coordinated execution of one or more prescribed applications. Distributed computing can be applied in peer-to-peer applications or client-server based applications, including providing cloud-based application services.

The Internet of Things (IoT) refers to interconnecting of uniquely identifiable embedded devices within a wide area network, such as the existing Internet infrastructure. The embedded devices typically have very low compute, store, network, or battery power capabilities, however the large number of embedded devices serving as sensor devices in the IoT architecture can result in a dramatically increased amount of data being supplied to destination computing devices for processing.

### BRIEF DESCRIPTION OF THE DRAWINGS

Reference is made to the attached drawings, wherein elements having the same reference numeral designations represent like elements throughout and wherein:

FIG. 1 illustrates an example system having an apparatus sending instructions to one or more network devices to enable distributed execution of a prescribed application by the network devices on behalf of a computing device, according to an example embodiment.

FIG. 2 illustrates another example system enabling network devices to determine an optimized path providing a minimal overall computing time for completing execution of a prescribed application, according to an example embodiment.

FIG. 3 illustrates an example implementation of any one of the devices of FIG. 1 or 2.

FIGS. 4A-4C summarize methods by the devices of FIGS. 1-3 of providing distributed execution of a prescribed application on behalf of a computing device, according to an example embodiment.

FIG. 5 illustrates an example network device providing distributed execution of at least a portion of a prescribed application on behalf of a computing device, according to an example embodiment.

### DESCRIPTION OF EXAMPLE EMBODIMENTS

### Overview

In one embodiment, a method comprises: determining application processing capabilities in one or more network devices, in a data network, for execution of at least a portion of a prescribed application on identifiable data packets from a requesting network device and destined for a computing device; and sending instructions to the one or more network devices, the instructions enabling the one or more network devices to execute at least the portion of the prescribed application, on behalf of the computing device, in response to detecting receipt of the identifiable data packets.

In another embodiment, an apparatus comprises a device interface circuit and a processor circuit. The device interface circuit is configured for communications with one or more network devices in a data network. The processor circuit is configured for determining application processing capabilities in the one or more network devices, for execution of at least a portion of a prescribed application on identifiable data packets from a requesting network device and destined for a computing device. The processor circuit also is configured for sending, via the device interface circuit, instructions to the one or more network devices, the instructions enabling the one or more network devices to execute at least the portion of the prescribed application, on behalf of the computing device, in response to detecting receipt of the identifiable data packets.

In another embodiment, logic is encoded in one or more non-transitory tangible media for execution by a machine and when executed by the machine operable for: determining application processing capabilities in one or more network devices, in a data network, for execution of at least a portion of a prescribed application on identifiable data packets from a requesting network device and destined for a computing device; and sending instructions to the one or more network devices, the instructions enabling the one or more network devices to execute at least the portion of the prescribed application, on behalf of the computing device, in response to detecting receipt of the identifiable data packets.

In another embodiment, a method comprises: receiving, by a network device in a data network, instructions enabling execution of at least a portion of a prescribed application on identifiable data packets, the identifiable data packets originating from a requesting network device and destined for execution of the prescribed application by a computing device; executing by the network device, on behalf of the computing device, at least a portion of the prescribed application on data packets received via the data network based on identifying the data packets as the identifiable data packets, and further based on determined available processing capabilities in the network device; and outputting as processed data packets, via the data network toward the computing device, the data packets having been executed on by the network device.

In another embodiment, an apparatus comprises a network interface circuit and a processor circuit. The network interface circuit is configured for receiving, via in a data network, instructions enabling execution of at least a portion of a prescribed application on identifiable data packets, the identifiable data packets originating from a requesting network device and destined for execution of the prescribed application by a computing device. The processor circuit is configured for executing, on behalf of the computing device, at least a portion of the prescribed application on data packets received by the network interface circuit based on identifying the data packets as the identifiable data packets, and further based on determined available processing capabilities in the apparatus. The network interface circuit is further configured for outputting as processed data packets, via the data network toward the computing device, the data packets having been executed on by the processor circuit.

In another embodiment, logic is encoded in one or more non-transitory tangible media for execution by a machine and when executed by the machine operable for: receiving, by a network device in a data network, instructions enabling execution of at least a portion of a prescribed application on identifiable data packets, the identifiable data packets originating from a requesting network device and destined for execution of the prescribed application by a computing device; executing by the network device, on behalf of the computing device, at least a portion of the prescribed application on data packets received via the data network based on identifying the data packets as the identifiable data packets, and further based on determined available processing capabilities in the network device; and outputting as processed data packets, via the data network toward the computing device, the data packets having been executed on by the network device.

### DETAILED DESCRIPTION

Particular embodiments enable network devices (e.g., network switch devices, network router devices, firewall devices, etc.) to execute distributed computing on behalf of a destination computing device executing a prescribed application for a requesting network device. The network devices can execute distributed computing on identifiable data packets from the requesting network device, on behalf of the destination computing device, based on executing at least a portion of the prescribed application using available application processing capabilities in the network devices.

All data networks, regardless of size or scope, rely on network devices for executing prescribed network device operations that provide the communications within the data network infrastructure. Larger data networks are implemented using a larger number of network devices and/or larger capacity network devices. Such network devices can be constructed and implemented using generic hardware components, including central processing unit (CPU) devices and/or multiple-core processor devices etc.; such prescribed network devices also can be constructed and implemented using specialized hardware components, including for example digital signal processing (DSP) circuitry and/or application specific integrated circuit (ASIC) devices. Even with the demands of network devices in executing prescribed network device operations in a data network, the network devices often can encounter reduced demand, resulting in under-utilization of the network devices.

The example embodiments can exploit the under-utilization of the network devices executing the prescribed network operations based on utilizing available application processing capabilities for distributed execution of at least a portion of the prescribed application executed by a computing device. The application processing capabilities are distinct and operate independently from native resources used in the network devices for executing the prescribed network device operations. Further, the application processing capabilities are subordinate to the native resources of the network devices; hence, any execution of any portion of a prescribed application on behalf of a computing device is always subordinate to the native resources of the network devices, such that execution of any portion of the prescribed application will never interfere with the native resources executing the prescribed network operations.

Hence, the example embodiments can provide a truly scalable distributed computing architecture that enables computing capacity to increase in direct proportion to an increase in the size of the data network. In particular, as network infrastructure capacity is increased for network-centric architectures such as cloud computing, fog computing, Internet of Things (IoT), Software Defined Networking (SDN), the example embodiments can provide a proportional increase in computing capacity among the network devices. Moreover, the distributed computing can be initiated dynamically by any apparatus, for example a centralized controller or a destination computing device that can dynamically install at least portions of a prescribed application to network devices along a network path between the requesting network device and the destination computing device. Further, the network devices can add computing metrics as an optimization metric for calculating an optimized path for routing data packets toward a destination computing device, where the optimized path can provide a minimal overall computing time.

Hence, the example embodiments can reduce processing burdens of a destination computing device, and can even reduce the overall computing time for completing execution of a prescribed application on identifiable data packets, based on routing the identifiable data packets along an optimized path including one or more network devices that can execute successive portions of the prescribed application before delivery to the destination computing device. The distributed computing provided by the example embodiments can provide dramatic improvements in overall computing time, especially when a computing device 12 needs to execute the prescribed application for hundreds or even thousands of different network devices 16.

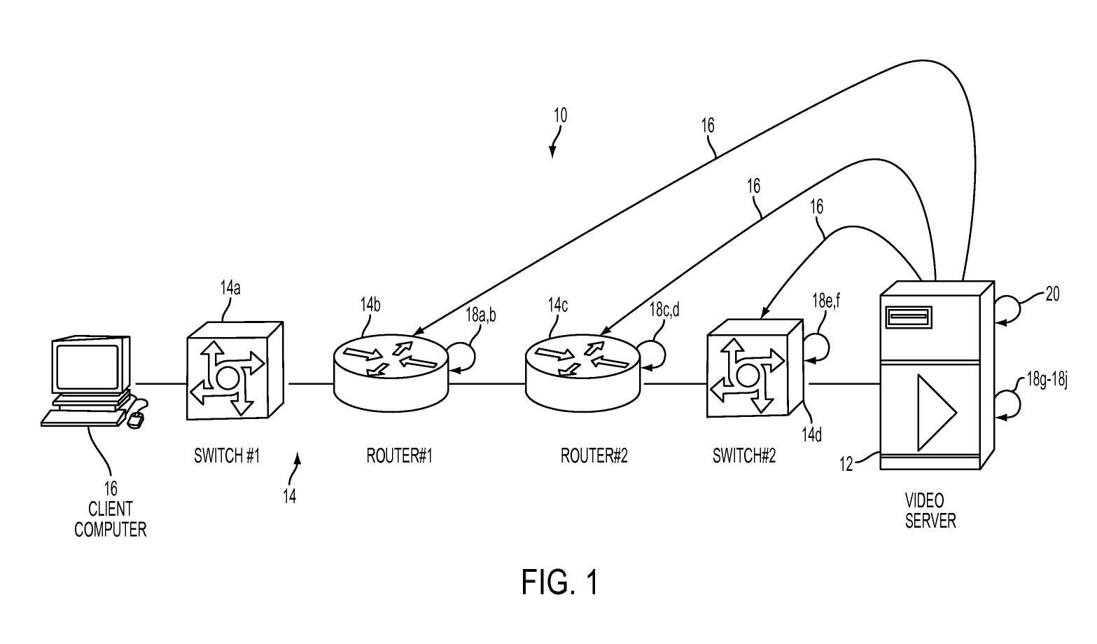

FIG. 1 is a diagram illustrating an example data network 10 having an apparatus 12 and one or more network devices 14, where the apparatus 12 can send instructions 16 to the one or more network devices 14 to execute at least a portion 18 of a prescribed application 20 for a requesting network device 16, according to an example embodiment. Each apparatus 12, 14, 16 is a physical machine (i.e., a hardware device) configured for implementing network communications with other physical machines via the network 10. The term “configured for” or “configured to” as used herein with respect to a specified operation refers to a device and/or machine that is physically constructed (i.e., manufactured) and arranged to perform the specified operation. Hence, each apparatus 12, 14, 16 is a network-enabled machine implementing network communications via the network 10.

Each network device 14 is configured for forwarding data packets output from the requesting network device 16 to the computing device 12, illustrated as a video server. The term “network device” as used in this specification and claims refers to any apparatus (i.e., machine) that can establish data links for forwarding data packets originated from the requesting network device 16 and destined for the destination computing device 12; in other words, a “network device” is any network-based device in any path between the originating requesting network device 16 (e.g., a client computer, a sensor device such as a video camera, microphone, etc.) and the destination computing device 12, typically a server device.

As described in further detail below, the apparatus 12 enables distributed computing in the network devices 14 based on determining application processing abilities in one or more of the network devices 14, where “application processing capabilities” as used in the specification and claims refers to the ability of a corresponding network device 14 to execute at least a portion 18 of a prescribed application 20 on identifiable data packets originating from a requesting network device 16. The prescribed application 20 can be any OSI layer 7 application that typically is executed on a server device 12, for example video compression software executed on a video server. Hence, “application processing capabilities” can include an identification of whether a network device 14 has the required hardware to execute at least a portion 18 of a prescribed application 20, as well as an identification of whether the network device 14 ever has any available hardware capacity that is not reserved exclusively for any native resources of the network device for execution of the corresponding prescribed network device operations.

For example, the apparatus 12 can determine that the network device 14a (e.g., a link layer switch) does not have application processing capabilities because it does not have hardware and/or executable software resources to accept instructions 16, via the network 10, for executing at least a portion 18 of a prescribed application 20; the apparatus 12 also can determine that the network devices 14b, 14c, and 14d have sufficient application processing capabilities (in the form of hardware resources, executable software resources, and available capacity) to execute at least a portion 18 of a prescribed application 20 normally executed by the apparatus 12.

In response to the apparatus 12 determining that the network devices 14b, 14c, and 14d are capable of executing at least a portion 18 of a prescribed application 20, the apparatus 12 can send instructions 16 to the network devices 14b, 14c, and 14d that enable the network devices 14b, 14c, and 14d to execute at least portions 18 of the prescribed application 20.

Hence, each of the network devices 14b, 14c, and 14d can execute a corresponding portion of the prescribed application and output corresponding processed data packets: for example, if the prescribed application 18 has ten (10) portions (18a-18j) that need to be executed in sequence, the network device 14b can execute the application portions 18a and 18b on the original data packets received from the requesting devices 16 via the switch 14a, and output processed data packets (“first generation processed data packets”) to the next hop network device 14c; the network device 14c can execute the application portions 18c and 18d on the first generation processed data packets received from the network device 14b and output second generation processed data packets to the next hop network device 14d; the network device 14d can execute the application portions 18e and 18f on the second generation processed data packets and output third-generation processed data packets to the destination computing device 12.

Hence, instead of executing the entire prescribed application 18 on the original data packets output by the requesting device 16, the computing device 12 can complete the execution of the prescribed application 18 based on executing the application portions 18g, 18h, 18i, and 18j on the third-generation processed data packets output by the network device 14d. As described below, the application portions 18a through 18f can be implemented as one or more executable serialized Java class elements.

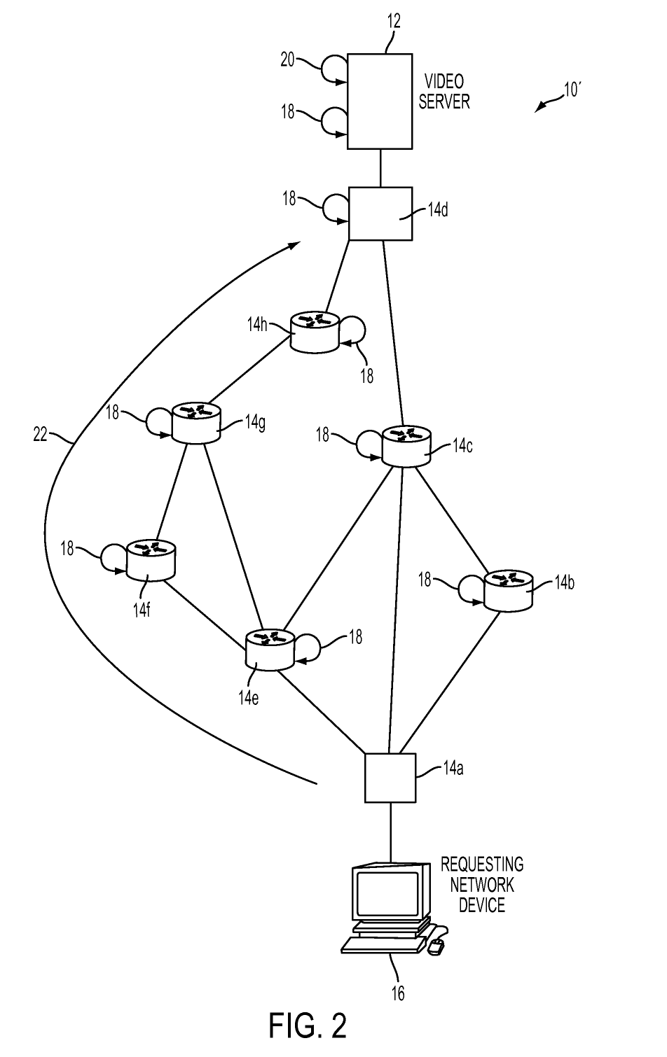

FIG. 2 illustrates another example system 10′ that enables the network devices 14 to utilize computing metrics as a routing metric for determining an optimized path 22 providing a minimal overall computing time for completing execution of the prescribed application 20, according to an example embodiment. Conventional routing protocols (e.g., Open Shortest Path First—OSPF) assume that the best path for reaching a destination device 12 is the path providing the shortest number of hops.

According to an example embodiment, computing metrics are added as part of the routing protocol optimization, such that the optimized path 22 for reaching a destination device 12 can be a path providing a minimal overall computing time for completing execution of the prescribed application 18. For example, assume that each of the “capable” network devices 14b-14h (i.e., those network devices capable of executing at least one portion 18 of the prescribed application 20) can advertise their relative application processing capabilities as part of advertise computing metrics that are advertised with other routing metrics according to a prescribed routing protocol: the network devices 14b, 14c, 14d, 14, and 14h each can advertise that they can execute two portions 18 of the application 20, whereas the network devices 14e and 14g advertise the taken execute only one portion 18 of the application 20.

Hence, the network devices 14b-14h can determine that the path “P1” along the sequence of capable network devices 14e-14f-14g-14h-14d provides the optimum path 22, as the path “P1” can execute a total of eight (8) of the portions 18a-18h, requiring the destination computing device 12 to execute only the last two portions 18i and 18j to complete execution of the prescribed application 20; the path “P2” along the sequence of network devices 14e-14g-14h-14d and the path “P3” along the sequence of network devices 14b-14c-14d each can execute a total of six (6) of the portions 18a-18f, requiring the destination computing device 12 to execute the last four portions 18g-18j; the path “P4” along the sequence of network devices 14e-14c-14d can execute a total of five (5) of the portions 18a-18e, requiring the destination computing device 12 to execute the last five portions 18f-18j; and the shortest-hop path “P5” along the sequence of network devices 14c-14d provides the longest execution time, since the shortest hop path “P5” can only execute a total of four (4) of the portions 18a-18d, requiring the destination computing device 12 to execute the last six (6) portions 18e-18j.

Hence, the longest path “P1” can provide the optimized path for reaching the computing device 12 relative to the overall computing time for completing execution of the prescribed application 20, since the executable portions 18 can be distributed along a larger number of network devices 14, minimizing the processing requirements of the destination computing device 12. Hence, the delay encountered by a user of the requesting network device and 16 can be substantially reduced despite the additional number of hops encountered along the optimized path 22, especially if the propagation delay is less than the computation time per each computation cycle for a corresponding portion 18. Further, even though the network device 14 may execute the portions at a slower compute speed than the computing device 12, overall time savings can still be achieved in cases where the destination computing device 12 would otherwise be burdened with managing hundreds or thousands of different requests from different requesting network devices 16.

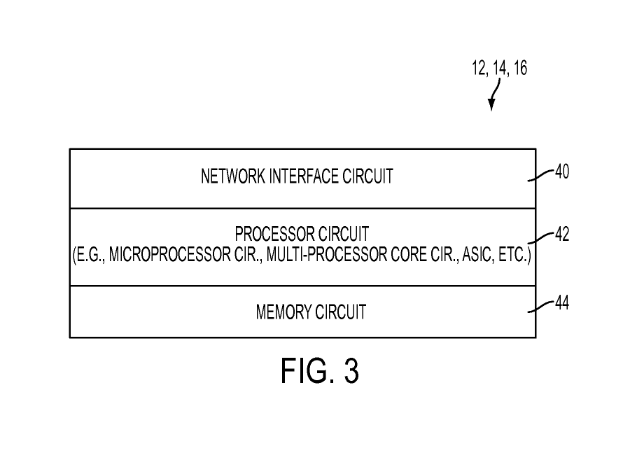

FIG. 3 illustrates an example implementation of any one of the devices 12, 14, and/or 16 of FIG. 1 or 2, according to an example embodiment.

Each apparatus 12, 14, and/or 16 can include a device interface circuit (i.e., a network interface circuit) 40, a processor circuit 42, and a memory circuit 44. The device interface circuit 40 can include one or more distinct physical layer transceivers for communication with any one of the other devices 12, 14, and/or 16; the device interface circuit 40 also can include an IEEE based Ethernet transceiver for communications with the devices of FIG. 1 or 2 via any of the links (e.g., a wired or wireless link, an optical link, etc.). The processor circuit 42 can be configured for executing any of the operations described herein, and the memory circuit 44 can be configured for storing any data or data packets as described herein.

Any of the disclosed circuits of the devices 12, 14, and/or 16 (including the device interface circuit 40, the processor circuit 42, the memory circuit 44, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC) or a digital signal processor (DSP) device. Any of these circuits also can be implemented using a software-based executable resource that is executed by a corresponding internal processor circuit such as a microprocessor circuit (not shown) and implemented using one or more integrated circuits, where execution of executable code stored in an internal memory circuit (e.g., within the memory circuit 44) causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 44 can be implemented, for example, using a non-volatile memory such as a programmable read only memory (PROM) or an EPROM, and/or a volatile memory such as a DRAM, etc.

Further, any reference to “outputting a message”, “outputting a packet”, or “outputting an instruction” (or the like) can be implemented based on creating the message/packet in the form of a data structure and storing that data structure in a non-transitory tangible memory medium in the disclosed apparatus (e.g., in a transmit buffer). Any reference to “outputting a message” or “outputting a packet” (or the like) also can include electrically transmitting (e.g., via wired electric current or wireless electric field, as appropriate) the message/packet stored in the non-transitory tangible memory medium to another network node via a communications medium (e.g., a wired or wireless link, as appropriate) (optical transmission also can be used, as appropriate). Similarly, any reference to “receiving a message” or “receiving a packet” (or the like) can be implemented based on the disclosed apparatus detecting the electrical (or optical) transmission of the message/packet on the communications medium, and storing the detected transmission as a data structure in a non-transitory tangible memory medium in the disclosed apparatus (e.g., in a receive buffer). Also note that the memory circuit 44 can be implemented dynamically by the processor circuit 42, for example based on memory address assignment and partitioning executed by the processor circuit 42.

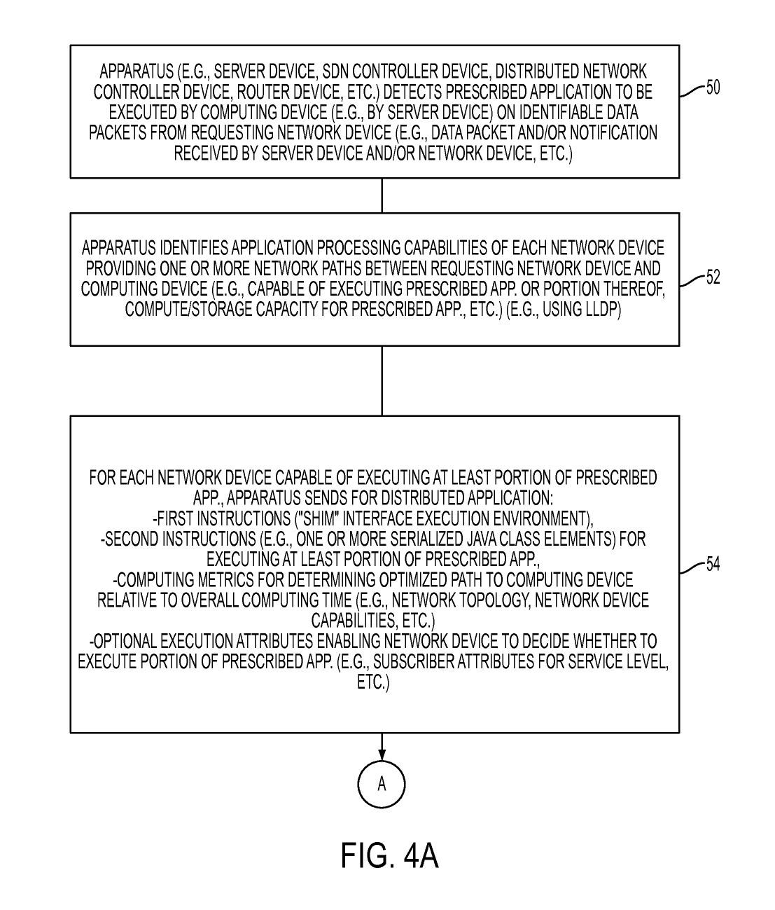

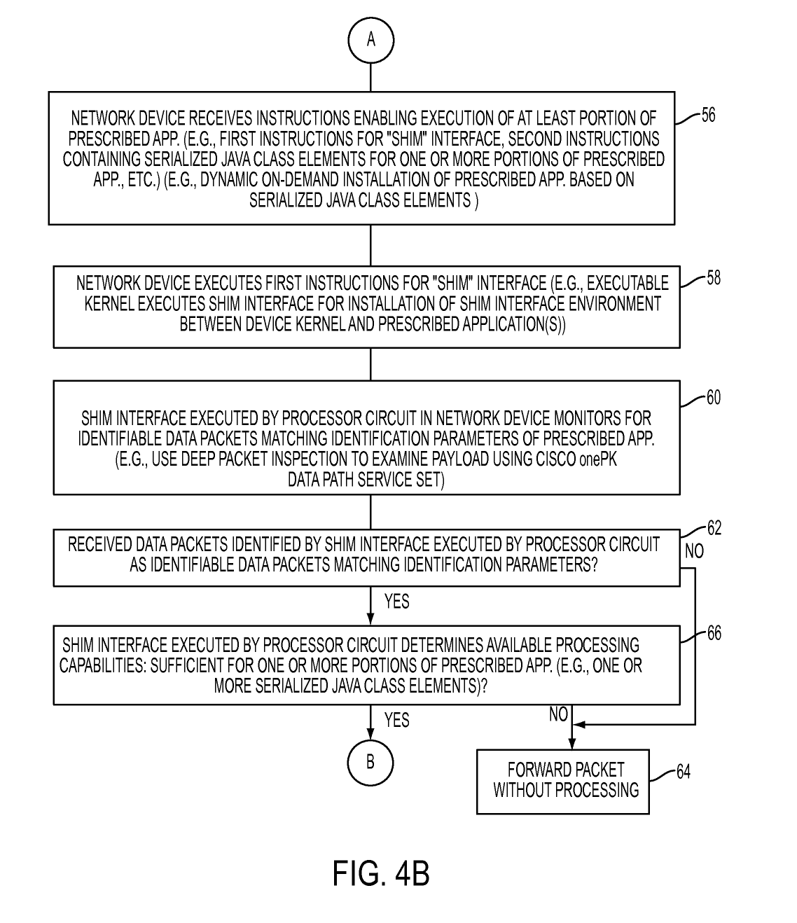

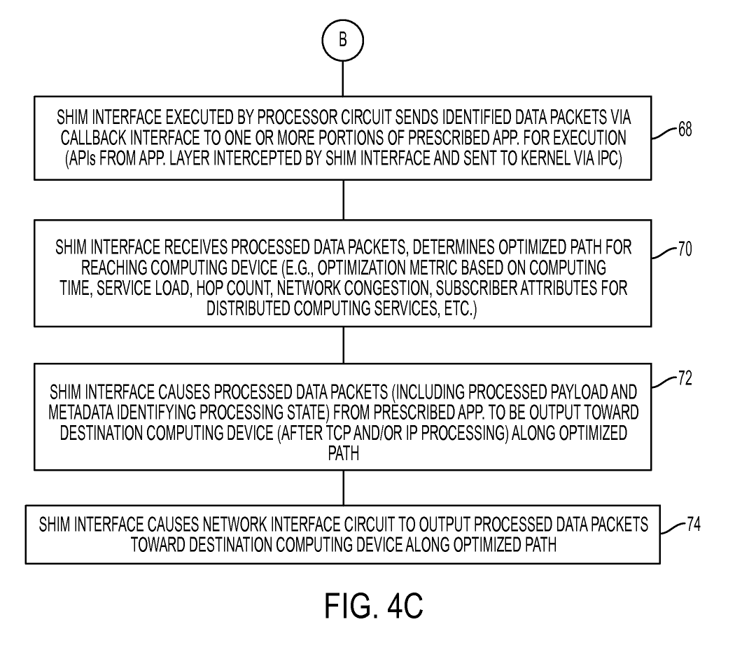

FIGS. 4A-4C summarize methods by the devices of FIGS. 1-3 of providing distributed execution of a prescribed application on behalf of a computing device, according to an example embodiment.

The operations described with respect to any of the Figures can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

In addition, the operations described with respect to any of the Figures can be performed in any suitable order, or at least some of the operations in parallel. Execution of the operations as described herein is by way of illustration only; as such, the operations do not necessarily need to be executed by the machine-based hardware components as described herein; to the contrary, other machine-based hardware components can be used to execute the disclosed operations in any appropriate order, or at least some of the operations in parallel.

Referring to FIG. 4A, the processor circuit 42 of an apparatus 12 can determine in operation 50 a prescribed application 20 to be executed by a destination computing device 12 on identifiable data packets originating from a requesting network device 16. The apparatus detecting in operation 50 the prescribed application 20 to be executed can be any network-based device, for example the server device 12, a software defined network (SDN) controller device, a distributed network controller device, a router device, etc. The prescribed application 20 to be executed can be detected by various techniques, for example initial detection of the data flow originating from the client device 16 using deep packet inspection, receiving a notification from either the destination computing device 12 and/or the requesting network device 16, a scheduled operation, etc. To simplify discussion, it will be assumed that the operations of FIG. 4A are executed by the destination computing device 12.

The processor circuit 42 of the video server 12 can determine in operation 52 the processing capabilities of each network device 14 providing one or more network paths between the requesting network device 16 and the destination computing device 12. For example, the processor circuit 42 of the video server 12 can use LLDP to determine that the network device 14a is incapable of any application processing capabilities, whereas the network devices 14b-14d, 14f, and 14h can execute up to two portions 18 of the prescribed application 20, and the network devices 14e and 14g can execute one portion 18 of the prescribed application 20. Other policies and protocols can be deployed that limit the amount of work that a capable network device 14 can be allocated for a given application 20.

In response to determining the application processing capabilities of each of the network devices 14, the processor circuit 42 of the video server 12 in operation 54 can send instructions 16 to each of the capable network devices 14b-14h that enable the capable network devices to execute at least one or more portions 18 of the prescribed application 20 on behalf of the computing device 12. For example, the instructions 16 can include first instructions, second instructions, computing metrics, and optional execution attributes.

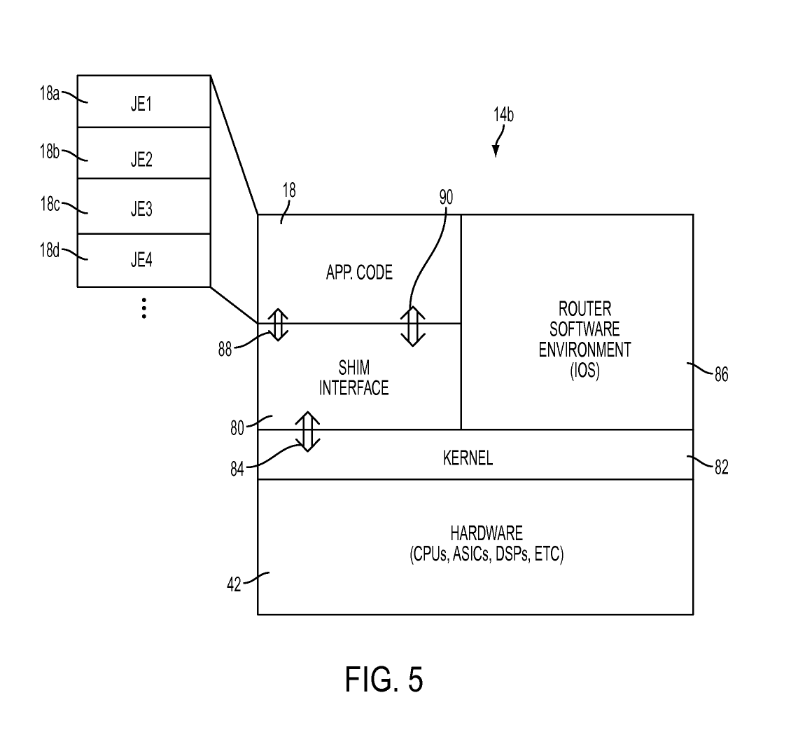

The first instructions can include instructions for implementing a “shim” interface execution environment (80 of FIG. 5), and the second instructions can include instructions (e.g., one or more serialized Java class elements) for executing one or more portions 18 of the prescribed application 20). The shim interface execution environment 80 executed by the processor circuit 42 of the capable network device 14 establishes an interface between a kernel 82 executed natively in the network device 14 and the portions 18 of the application 20. As described in further detail below, the shim interface execution environment 80 also can perform deep packet inspection of received data packets to determine which of the available portions 18 should be executed, depending on the identified application state of the payload inside the received data packets.

The second instructions can include one or more serialized Java class elements for executing one or more portions 18 of the prescribed application 20. For example, the prescribed application 20 can be implemented as the portions 18 executed in a prescribed sequence 18a-18j, where each portion 18 can be implemented as a corresponding Java class element. Hence, a network device 14 can receive all the serialized Java class elements, enabling the shim interface execution environment 80 to select one or more of the serialized Java class elements depending on the identified application state detected during deep packet inspection of the payload inside the received data packets. Alternative techniques can be used to implement the second instructions for executing one or more portions 18; for example, bytecodes or some other meta-instruction. Hence, use of serialized Java class elements is one example of the portions 18.

The instructions 16 also can include computing metrics for determining the optimized path 22 illustrated in FIG. 2. For example, the computing metrics can specify the total number of portions 18 required for execution, and the relative processing requirements for each portion 18 (e.g., number of execution cycles, etc.); the computing metrics also can specify network topology according to a prescribed routing protocol, network device capabilities (e.g., the number of portions that can be executed by an identified network device 14, etc.). The instructions 16 also can include optional execution attributes that enable each network device 14 to decide whether to execute a portion 18 of the prescribed application 20: example attributes can include subscriber attributes for a given service level, where data flows associated with higher service levels can be granted distributed computing along a higher performance path (e.g., the optimized path 22), whereas data flows associated with lower service levels are allocated to paths that provide a higher execution time.

Referring to FIG. 4B, the device interface circuit 40 of a capable network devices 14 can receive in operation 56 the instructions output by the video server 12 in operation 54 of FIG. 4A, for example as a dynamic installation in response to the packet flow detected by the video server 12. The instructions received in operation 56 enable the processor circuit 42 (e.g., microprocessor circuit, multi-processor core circuit, ASIC, and/or DSP, etc.) of the capable network device 14 to execute in operation 58 the first instructions for installation and instantiation of the shim interface 80 between the kernel 82 and the portions 18 of the prescribed application 20, illustrated as application code in FIG. 5.

FIG. 5 illustrates the executable processes in any one of the capable network devices 14 (e.g., 14b), according to an example embodiment. The capable network device 14b can cause its native executable kernel 82 to execute the shim interface 80, including establishment of an interprocess communication 84 between the shim interface and the kernel 82. The kernel 82 also provides an interface between the hardware of the processor circuit 42 and native software 86, for example router software executed by the hardware 42 under the control of the kernel 82 in order to provide the required network operations.

Upon execution of the shim interface 80 by the processor circuit 42, the shim interface 80 can monitor in operation 64 identifiable data packets matching identification parameters of the prescribed application 20. For example, the shim interface 80 can execute deep packet inspection of received data packets in order to examine the payload of the received data packets. Deep packet inspection can be implemented, for example, using the commercially available Cisco onePK DataPath Service Set from Cisco Systems, San Jose Calif.

The shim interface 80 in operation 62 determines whether any of the received data packets received by the device interface circuit 40 are identified as identifiable data packets matching identification parameters for the prescribed application 20 or any of the associated portions 18. As noted previously, the shim interface 80 can serve as an interface for the portions 18 of multiple different applications 20 for the same or different destination computing devices 12. If in operation 62 the received data packets do not match any identification parameters for any existing application 20 or portion 18 thereof, the shim interface 80 executed by the processor circuit 42 can forward the received data packets via the device interface circuit 40 to the next hop destination using existing routing protocols without further processing in operation 64.

If in operation 62 the received data packets are identified by the shim interface 80 as identifiable data packets for one of the applications 20 or one of the portions 18, the shim interface 80 determines in operation 66 whether sufficient resources are available in the network device 14 for execution of one or more portions 18 of the prescribed application 20: if the shim interface 80 determines that there are insufficient processing capabilities (e.g., too many device resources are allocated for existing tasks), the shim interface 80 causes the received data packets to be forwarded to the next hop destination in operation 64 without further processing. If, however, the shim interface determines available processing capabilities to execute one or more of the portions 18 on the received data packets, the shim interface in operation 68 of FIG. 4C sends the identified packets via a callback interface (88 of FIG. 5) to one or more of the portions 18 of the prescribed application 20 for execution: if any of the portions 18 reference an application programming interface request 90, the shim interface 80 can intercept the API request, schedule the API request among other pending requests, and forward the request to the kernel 82 via the interprocess communication 84. Hence, the shim interface 80 enables the hardware-based execution of the portions 18 to be controlled by the kernel 82 to ensure that the execution of the portions 18 are subordinate to any of the native operations executed by the devices software 86.

In response to the shim interface 80 receiving in operation 70 the processed data packets from the executed portion 18, the code shim 80 can determine the optimized path 22 for reaching the computation device 12, for example based on executing optimization according to optimization metrics such as computing time, service look, hop count, network congestion, subscriber attributes for distributed computing services, etc. Depending on implementation, determination of the optimized path 22 can be based on the shim interface 80 sending an optimization request to the native routing software 86 via the interprocess communication 84 and the kernel 82, ensuring the kernel 82 maintains exclusive control over all device operations. The shim interface 80 in operation 72 completes packaging of the processed data packets, including adding any metadata necessary for identifying processing state in the processed payload, and performing any TCP and/or IP processing that is necessary in response to the processing of the data packets payload by the one or more portions 18 of the application 20, including updating the next hop identifier for outputting toward the destination computing device 12 along the optimized path 22. The shim interface 80 in operation 74 causes the network interface circuit 40 to output the processed data packets toward the destination computing device 12 along the optimized path 22.

Hence, a capable network device 14 can execute at least a portion 18 of a prescribed application 20 on behalf of a destination computing device 12 on data packets received via the data network 10 that originated from a requesting network device 16. As described previously, subsequent processing can be executed by next hop routers 14 along each hop, until received by the video server 12.

According to the example embodiments, idle resources within network devices can be exploited in order to reduce processing requirements by a destination computing device. Hence, the example embodiments enable dynamic deployment of a distributed computing network on an on-demand basis. The scheduling of work can follow packet flows throughout the network, enabling an increase in the available compute resources based on redundant paths, equal cost multipath routing, or performance routing. Network devices also can communicate amongst themselves to identify an optimal path based on available device resources. Selective execution based on subscriber attributes and/or service level also enables differentiated services in a scalable manner. The example embodiments are applicable to different network-based technologies, including cloud computing, software defined networking, distributed computing in an Internet of Things deployment, etc.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
determining application processing capabilities in one or more network devices, in a data network, for execution of at least a portion of a prescribed application on identifiable data packets from a requesting network device and destined for a computing device; and
sending instructions to the one or more network devices, the instructions enabling the one or more network devices to execute at least the portion of the prescribed application, on behalf of the computing device, in response to detecting receipt of the identifiable data packets.

2. The method of claim 1, wherein the instructions further include computing metrics that enable the one or more network devices to determine an optimized path for reaching the computing device relative to an overall computing time for completing execution of the prescribed application on the identifiable data packets.

3. The method of claim 2, wherein the computing metrics enable the one or more network devices to determine an optimized path providing a minimal overall computing time for completing execution of the prescribed application on the identifiable data packets.

4. The method of claim 2, wherein the instructions further include subscriber attributes that enable the one or more network devices to determine the optimized path relative to the overall computing time and the subscriber attributes relative to a user of the requesting network device.

5. The method of claim 1, wherein the instructions include first executable code, which when executed by the one or more network devices, provides an interface between the corresponding one or more network device and at least the portion of the prescribed application according to the corresponding application processing abilities.

6. The method of claim 1, wherein the instructions include one or more executable serialized Java class elements for execution of the corresponding portion of the prescribed application by the one or more network devices on based on deep packet inspection of the identifiable data packets.

7. An apparatus comprising:
a device interface circuit configured for communications with one or more network devices in a data network; and
a processor circuit configured for determining application processing capabilities in the one or more network devices, for execution of at least a portion of a prescribed application on identifiable data packets from a requesting network device and destined for a computing device;
the processor circuit further configured for sending, via the device interface circuit, instructions to the one or more network devices, the instructions enabling the one or more network devices to execute at least the portion of the prescribed application, on behalf of the computing device, in response to detecting receipt of the identifiable data packets.

8. The apparatus of claim 7, wherein the instructions further include computing metrics that enable the one or more network devices to determine an optimized path for reaching the computing device relative to an overall computing time for completing execution of the prescribed application on the identifiable data packets.

9. The apparatus of claim 8, wherein the computing metrics enable the one or more network devices to determine an optimized path providing a minimal overall computing time for completing execution of the prescribed application on the identifiable data packets.

10. The apparatus of claim 8, wherein the instructions further include subscriber attributes that enable the one or more network devices to determine the optimized path relative to the overall computing time and the subscriber attributes relative to a user of the requesting network device.

11. The apparatus of claim 7, wherein the instructions include first executable code, which when executed by the one or more network devices, provides an interface between the corresponding one or more network device and at least the portion of the prescribed application according to the corresponding application processing abilities.

12. The apparatus of claim 7, wherein the instructions include one or more executable serialized Java class elements for execution of the corresponding portion of the prescribed application by the one or more network devices on based on deep packet inspection of the identifiable data packets.

13. Logic encoded in one or more non-transitory tangible media for execution by a machine and when executed by the machine operable for:
determining application processing capabilities in one or more network devices, in a data network, for execution of at least a portion of a prescribed application on identifiable data packets from a requesting network device and destined for a computing device; and
sending instructions to the one or more network devices, the instructions enabling the one or more network devices to execute at least the portion of the prescribed application, on behalf of the computing device, in response to detecting receipt of the identifiable data packets.

14. A method comprising:
receiving, by a network device in a data network, instructions enabling execution of at least a portion of a prescribed application on identifiable data packets, the identifiable data packets originating from a requesting network device and destined for execution of the prescribed application by a computing device;
executing by the network device, on behalf of the computing device, at least a portion of the prescribed application on data packets received via the data network based on identifying the data packets as the identifiable data packets, and further based on determined available processing capabilities in the network device; and
outputting as processed data packets, via the data network toward the computing device, the data packets having been executed on by the network device.

15. The method of claim 14, wherein the receiving includes receiving computing metrics associated with other network devices in the data network, the outputting include determining an optimized path for reaching the computing device relative to an overall computing time for the identifiable data packets.

16. The method of claim 14, wherein the receiving includes receiving subscriber attributes associated with providing distributed computing services, the executing based on determining the requesting network device has associated subscriber attributes for the distributed computing services.

17. The method of claim 14, wherein the receiving includes receiving first executable code, the executing including executing the first executable code for establishment of an interface between a kernel executed natively in the network device and at least the portion of the prescribed application based on the determined available processing capabilities in the network device.

18. The method of claim 17, wherein the executing includes:
the interface identifying the data packets as the identifiable data packets for the prescribed application;
the interface determining the available processing capabilities in the network devices; and
the interface sending the identifiable data packets to received second executable code, executed using at least a portion of the available processing capacity, for execution of at least the portion of the prescribed application.

19. The method of claim 14, wherein the receiving includes receiving one or more executable serialized Java class elements for execution of the corresponding portion of the prescribed application.

20. An apparatus comprising:
a network interface circuit configured for receiving, via in a data network, instructions enabling execution of at least a portion of a prescribed application on identifiable data packets, the identifiable data packets originating from a requesting network device and destined for execution of the prescribed application by a computing device; and
a processor circuit configured for executing, on behalf of the computing device, at least a portion of the prescribed application on data packets received by the network interface circuit based on identifying the data packets as the identifiable data packets, and further based on determined available processing capabilities in the apparatus;
the network interface circuit further configured for outputting as processed data packets, via the data network toward the computing device, the data packets having been executed on by the processor circuit.

21. The apparatus of claim 20, wherein the network interface circuit is configured for receiving computing metrics associated with other network devices in the data network, the processor circuit configured for determining an optimized path for reaching the computing device relative to an overall computing time for the identifiable data packets.

22. The apparatus of claim 20, wherein the network interface circuit is configured for receiving subscriber attributes associated with providing distributed computing services, the processor circuit configured for execution at least the portion of the prescribed application based on determining the requesting network device has associated subscriber attributes for the distributed computing services.

23. The apparatus of claim 20, wherein the network interface circuit is configured for receiving first executable code, the processor circuit configured for executing the first executable code for establishment of a virtualized interface between a kernel executed natively by the processor circuit and at least the portion of the prescribed application based on the determined available processing capabilities in the apparatus.

24. The apparatus of claim 23, wherein the processor circuit is configured for:
causing the virtualized interface to identify the data packets as the identifiable data packets for the prescribed application;
causing the virtualized interface to determine the available processing capabilities in the apparatus; and
causing the virtualized interface to send identified data packets to received second executable code, executed using at least a portion of the available processing capacities, for execution of at least the portion of the prescribed application.

25. The apparatus of claim 20, wherein the network interface circuit is configured for receiving one or more executable serialized Java class elements for execution of the corresponding portion of the prescribed application.

26. Logic encoded in one or more non-transitory tangible media for execution by a machine and when executed by the machine operable for:
receiving, by a network device in a data network, instructions enabling execution of at least a portion of a prescribed application on identifiable data packets, the identifiable data packets originating from a requesting network device and destined for execution of the prescribed application by a computing device;
executing by the network device, on behalf of the computing device, at least a portion of the prescribed application on data packets received via the data network based on identifying the data packets as the identifiable data packets, and further based on determined available processing capabilities in the network device; and
outputting as processed data packets, via the data network toward the computing device, the data packets having been executed on by the network device.
